(19) United States
(12) Patent Application Publication
(10) Pub. No.: US 2025/0278262 A1
(43) Pub. Date: Sep. 4, 2025

(54) SYSTEM AND METHOD FOR MACHINE LEARNING MODEL DEPLOYMENT

(71) Applicant: CITYBLOCK HEALTH, INC., Brooklyn, NY (US)

(72) Inventors: Keith INGERSOLL, Chicago, IL (US); Eric HILTON, Whitefish, MT (US)

(21) Appl. No.: 19/066,832

(22) Filed: Feb. 28, 2025

Related U.S. Application Data
(60) Provisional application No. 63/560,389, filed on Mar. 1, 2024.

(51) Int. Cl. G06F 8/65; G06F 8/71

(52) U.S. Cl. CPC G06F 8/65; G06F 8/71

(57) ABSTRACT

A method includes receiving a trained machine learned model, where the trained machine learned model is trained using a dataset stored at an analytics database. The method further includes storing an object version of the machine learned model at an object storage, storing a text version of the machine learned model at a machine learning deployment platform, and deploying, by the machine learning deployment platform, the machine learned model. The method further includes storing output of the machine learned model at the analytics database by appending the output data to the analytics database.

### CROSS-REFERENCE TO RELATED APPLICATIONS

This application claims the benefit of priority pursuant to 35 U.S.C. § 119 (e) to U.S. Provisional Patent Application No. 63/560,389, filed Mar. 1, 2024, entitled “System and Method for Machine Learning Model Development,” which is hereby incorporated by reference herein in its entirety.

### FIELD

The present disclosure relates generally to systems for development and deployment of machine learning models.

### BACKGROUND

Version control is generally used in software development to increase collaboration between software development teams, improving efficiency and quality in software development. Current version control solutions for software generally do not fully implement version control for machine learning applications, as machine learning applications utilize both the models themselves and data used to train the models. For example, existing solutions may be difficult to scale, require large amounts of storage, and require manual input from developers to manage both models and associated data.

### SUMMARY

An example method disclosed herein includes receiving a trained machine learned model, where the trained machine learned model is trained using a dataset stored at an analytics database. The method further includes storing an object version of the machine learned model at an object storage, storing a text version of the machine learned model at a machine learning deployment platform, and deploying, by the machine learning deployment platform, the machine learned model. The method further includes storing output of the machine learned model at the analytics database by appending the output data to the analytics database.

An example system disclosed herein includes an analytics database, an object storage, and a machine learning deployment platform. The machine learning deployment platform is in communication with the analytics database and the object storage. The machine learning platform is configured to receive a trained machine learned model, where the machine learned model is trained using a dataset stored at the analytics database. The machine learning platform is further configured to store a text version of the machine learned model at the machine learning deployment platform, store an object version of the machine learned model at the object storage, deploy the machine learned model, and store output of the machine learned model at the analytics database by appending the output to data at the analytics database.

Example one or more non-transitory computer readable media disclosed herein are encoded with instructions which, when executed by one or more processors of a machine learning deployment platform, cause the machine learning platform to deploy a trained machine learned model, execute one or more jobs using the machine learned model, and store output of the machine learned model at an analytics database by appending the output to existing data at the analytics database.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 illustrates an example machine learning deployment platform in communication with various computing systems.

FIG. 2 is a schematic diagram of an example machine learning deployment platform.

FIG. 3 is a schematic diagram of an example computer system implementing various embodiments in the examples described herein.

FIG. 4 illustrates an example process for deploying an ML model using a machine learning deployment platform.

FIG. 5 illustrates an example process for utilizing an ML model using a machine learning deployment platform.

FIG. 6 illustrates an example process for updating an ML model using a machine learning deployment platform.

### DETAILED DESCRIPTION

Machine learning (ML) models are becoming increasingly complex and are trained on increasingly large datasets. ML models are often updated frequently, such as when new data is available for training, changes are made to types of data used to train models, output generated by the model is used in a new way, and the like. Datasets used to train ML models and/or including output from ML models are similarly updated as ML models generate output, updated models generate output, and the like. Tracking and versioning such updates is difficult and utilizes large amounts of computing resources, making the development cycle for ML models cumbersome and difficult to scale.

The ML deployment platform described herein manages datasets and ML models using text editing within the platform, simplifying maintenance of large datasets and multiple versions of ML models while also enabling the use of code versioning and reviewing techniques for auditing, collaboration and change management. For example, changes to ML models and data may be saved in an append only text history such that models can be reverted and the state of data at different times may be ascertained. Such text only appending eliminates unnecessary copies of large datasets and models, reducing the amount of computing resources used in the development of software incorporating ML models. As the text editing allows for use of code versioning and reviewing software, efficiency of development of such software is also improved. For example, collaboration between developers and versioning of models may be simplified as compared to other methods of developing and deploying ML models. Storing and utilizing text versions of models as well as providing a shared and immutable database further provides scalability of the platform over time.

The ML deployment platform described herein allows for efficient collaboration between developers. For example, versioning of ML models allows developers to access, develop, and utilize different versions of the ML models in various applications. The ML models may be versioned at the ML deployment platform using text only files, such that less storage is used at the ML deployment platform when compared to storing object versions of models directly at a deployment platform. Such text versions of the models may include pointers to a location where object versions of the models are stored, such that the object versions of the models may be accessed as needed by the ML deployment platform.

The ML deployment platform disclosed herein further allows for efficient collaboration between developers and external users. For example, ML models developed by software development and data science teams may utilize data collected, generated, and/or maintained by other teams within an organization. The ML deployment platform may utilize a remote analytics database accessible both by such external teams and developers. External users managing such data may write data to the analytics database independently of the internal ML team. ML models deployed using the ML deployment platform may write data to the analytics database in a scoped, append only mode, such that the data is available to external teams and the external teams can utilize output of models developed by development teams but not overwrite existing data. Data may be versioned within the analytics database such that it is possible to ascertain which data was used to train an ML model and which data was output from an ML model. Further, data does not need to be copied, reducing the amount of storage space needed for data and enabling scaling of the ML deployment platform. The analytics database may provide a shared and immutable data source for collaboration between various users within an organization.

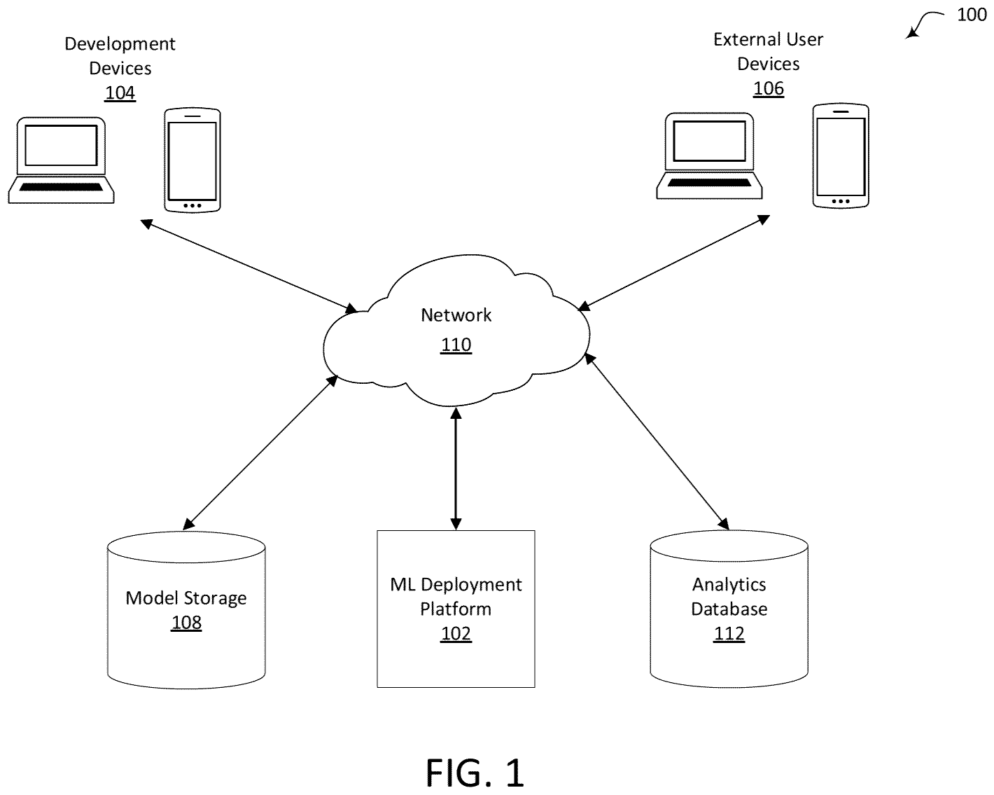

Turning to the figures, FIG. 1 illustrates an example ML deployment platform 102 in communication with various computing systems. Various development devices 104 and external user devices 106 may access the machine learning deployment platform 102 to deploy and test ML models, utilize deployed ML models to analyze data, and the like. For example, a development device 104 may access the ML deployment platform 102 to deploy a trained ML model, monitor and revise existing ML models deployed using the ML deployment platform 102, and the like. External user devices 106 may access the ML deployment platform 102 to, in various examples, utilize ML models deployed using the ML deployment platform 102.

The ML deployment platform 102 may generally be utilized to develop and deploy applications including ML models. For example, external user devices 106 may store data used to train models at an analytics database 112. A developer, using a development device 104, may access data at the analytics database 112 to generate an ML model or application including an ML model. An object version of the ML model may be stored at model storage 108, while a text version of the model may be provided to, and versioned by, the ML deployment platform 102. The ML deployment platform 102 may then deploy the application or model. That is, the ML deployment platform 102 may configure infrastructure and processing constructs (e.g., containers) to run an application including an ML model. In various examples, the output from such models may be written to the analytics database 112 such that output data may be analyzed or later used to train or generate additional ML models. For example, output data may be analyzed to automate decision making or other processes for businesses or organizations.

The ML deployment platform 102 may be generally implemented by a computing device or combinations of computing resources in various embodiments. In various examples, the ML deployment platform 102 may be implemented by one or more servers, cloud computing resources, and/or other computing devices. The ML deployment platform 102 may, for example, utilize various processing resources to deploy ML models and/or manage data associated with ML models. The ML deployment platform 102 may further include memory and/or storage locations to store program instructions for execution by the processor and various data utilized by the ML deployment platform 102.

Development devices 104, external user devices 106, and/or other user devices in communication with the ML deployment platform 102 may be devices belonging to an end user utilizing the ML deployment platform 102, such as end users developing new ML models and utilizing the ML deployment platform 102 to deploy such models, end users storing or retrieving data utilized to train such models or output by such models, and to perform other functions. In various embodiments, development devices 104 and external user devices 106 may be authenticated by an authentication service prior to accessing the ML deployment platform 102. Further, development devices 104 and external user devices 106 may be associated with different types of permissions for accessing the ML deployment platform 102. For example, development devices 104 may have permission to deploy new models at the ML deployment platform 102 while external user devices 106 may have permission to write new data directly to data stores utilized by the ML deployment platform 102 and may access only certain models deployed using the ML deployment platform 102.

In various embodiments, development devices 104, external user devices 106, and/or other user devices in communication with the ML deployment platform 102 may be implemented using any number of computing devices including, but not limited to, a computer, a laptop, mobile phone, smart phone, wearable device (e.g., AR/VR headset, smart watch, smart glasses, or the like), smart speaker, vehicle (e.g., automobile), or appliance. Generally, the user devices may include one or more processors, such as a central processing unit (CPU), tensor processing unit (TPU) and/or graphics processing unit (GPU). The user devices may generally perform operations by executing executable instructions (e.g., software) using the processor(s).

The ML deployment platform 102 may be in communication with various data stores in various embodiments. For example, the ML deployment platform 102 may be in communication with model storage 108 and an analytics database 112. In various examples, model storage 108 may store object code versions of models deployed using the ML deployment platform 102. For example, models may be stored as JSON blobs at model storage 108. The ML deployment platform 102 may access such object versions of the models as needed to, for example, deploy and test the models. The analytics database 112 may store various data, such as data used to train models, data generated by models deployed using the ML deployment platform 102, and the like. Each of model storage 108 and the analytics database 112 may be any type of data storage including cloud or remote storage locations or local storage locations. In some examples, model storage 108 and/or the analytics database 112 may be distributed over multiple storage locations.

The ML deployment platform 102 generally communicates with other computing systems and/or data stores via a network 110. The network 110 may be implemented using one or more of various systems and protocols for communications between computing devices. In various embodiments, the network 110 or various portions of the network 110 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, and the like.

Components of the ML deployment platform 102 and in communication with the ML deployment platform 102 are exemplary and may vary in some embodiments. For example, in some embodiments, the ML deployment platform 102 may be distributed across multiple computing elements, such that components of the ML deployment platform 102 communicate with one another through the network 110. Further, the ML deployment platform 102 and/or components of the ML deployment platform 102 may configure and/or instruct jobs to run on other computing devices, including various serverless jobs, configuration of containers, and the like. Further, in some embodiments, computing resources dedicated to the ML deployment platform 102 may vary over time based on various factors such as usage of the ML deployment platform 102. In some embodiments, the ML deployment platform 102 may communicate with multiple development devices 104, external user devices 106, and/or other systems not shown in FIG. 1.

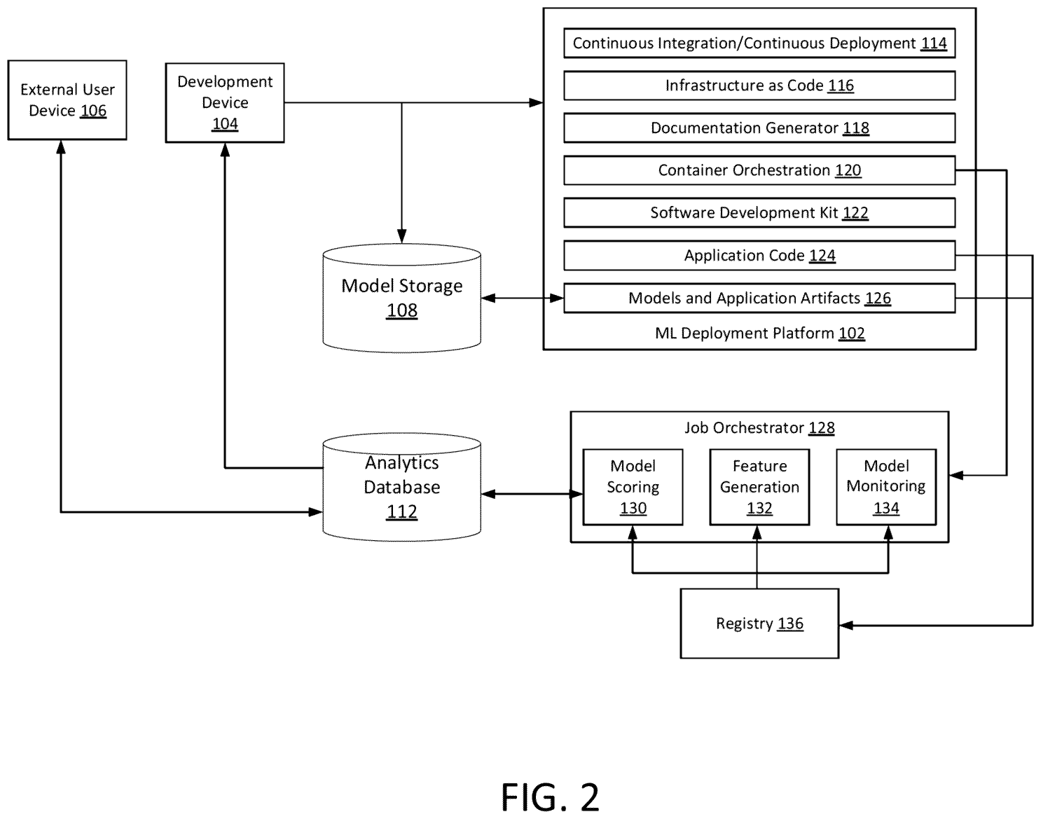

FIG. 2 is a schematic diagram of an example ML deployment platform 102. The ML deployment platform 102 generally deploys and manages ML models while managing various data associated with such models. For example, a developer may obtain data managed by the ML deployment platform 102 to train or develop an ML model, push the trained model to the ML deployment platform 102 to run the model, and schedule and run tests on the ML model. The ML deployment platform 102 may generally store the model, track different versions of the model, deploy the model, monitor output of the running model and store such output as text data, and perform other functions related to deployment and management of the model and its associated data, as described in further detail herein.

In various examples, the ML deployment platform 102 and various components of the ML deployment platform 102 may perform actions responsive to changes to code, such as saving a new ML model or application including an ML model, making changes to an existing model or application, and the like. For example, ML models or applications may be defined by code along with a Dockerfile or other file for configuring a container or other processing construct, and may be run inside of a container orchestration platform within the ML deployment platform 102. When deploying a new model or application, or making changes to an existing model or application, a developer may edit code, push the edited code to the central repository, have a colleague approve their changes, and merge the edited code. The ML deployment platform 102 may automate the remainder of actions associated with deploying new models or applications, such that developers may avoid other manual steps to put models and/or applications into production.

In various examples, the ML deployment platform 102 may include or utilize one or more hosts or combinations of compute resources, which may be located, for example, at one or more servers, cloud computing platforms, computing clusters, and the like. Generally, the ML deployment platform 102 may be implemented by compute resources at one or more servers, computing devices, and/or across a serverless architecture. The ML deployment platform 102 may generally be implemented by compute resources including hardware for memory and one or more processors. For example, the ML deployment platform 102 may utilize or include one or more processors, such as a CPU, GPU and/or programmable or configurable logic.

In some embodiments, various components of the ML deployment platform 102 may be distributed across various computing resources, such that components of the ML deployment platform 102 communicate with one another through the network 110 and/or using other communications protocols. For example, in some embodiments, the ML deployment platform 102 may be implemented as a serverless service, where computing resources for various components of the ML deployment platform 102 may be located across various computing environments (e.g., cloud platforms) and may be reallocated dynamically and/or automatically according to, for example, resource usage of the ML deployment platform 102. In various implementations, the ML deployment platform 102 may be implemented using organizational processing constructs such as functions implemented by worker elements allocated with compute resources, containers, virtual machines, and the like.

The ML deployment platform 102 may further communicate with various data stores storing data utilized by the ML deployment platform 102. Such data stores may be located at the same or separate computing environments as the ML deployment platform 102. As described with respect to FIG. 1, model storage 108 may generally store object code versions of models deployed using the ML deployment platform 102.

The ML deployment platform 102 may further communicate with a job orchestrator 128 and a registry 136. The registry 136 may register containers for new versions of applications and models configured by the ML deployment platform 102. The job orchestrator 128 may create various jobs based on configurations defined, for example, by development devices 104 interacting with the ML deployment platform 102. In various examples, the job orchestrator 128 may fetch containers from the registry 136 to perform jobs related to applications running inside such containers. For example, the job orchestrator 136 may create jobs for model scoring 130, feature generation 132, and model monitoring 134. The job orchestrator 136 may further communicate with the analytics database 112 to obtain various data used to run the configured jobs.

The output of jobs configured by the job orchestrator 128 may further be written to the analytics database 112 in an append only mode. That is, the job orchestrator 128 does not modify data already at the analytics database 112. Accordingly, should a new model or new version of a model generate output that is unexpected or incorrect, the data stored at the analytics database 112 is not affected. In various examples, such data may further be output with metadata indicating which model or application output the data, as well as when the data was output. Accordingly, data can be rolled back to earlier versions as needed.

The components of the ML deployment platform 102 generally perform some function responsive to a command or change in the code base. For example, receiving a new ML model or application including an ML model may cause a change in the code base. For example, a development device 104 may provide an updated version or new version of an application or model to the ML deployment platform 102 as well as various tests and deployment instructions for the application or model. The ML deployment platform 102 includes various components to version and deploy the application itself as well as data used to train the model, deploy the application or model, configure testing or other jobs related to the application or model, and the like.

Generally, the ML deployment platform 102 includes a software development kit 122 providing an interface for a development device 104 to interact with the ML deployment platform 102. For example, the software development kit 122 may include a Python library and command line interface (CLI), allowing a development device 104 to run commands, make changes to application code or provide new application code, configure tests of models or applications, and the like. Upon receipt of a change to the code base (e.g., receipt of a new model or application or update to an existing model or application), the software development kit 122 may run tests on new applications or models as well as push new code to the registry 136.

Upon a change to the code base, such as receipt of a new ML model, an object version (e.g., a JSON blob) of the model may be stored at model storage 108. A text version of the model (e.g. an MD5 hash) may be stored at models and application artifacts 126 of the ML deployment platform 102. Such text versions of the models may include or be associated with pointers to the object versions of the models stored at model storage 108. Application code for the updated model or application, including various code and associated Dockerfiles (e.g., code utilized to configure containers) may be stored at application code 124. For each changed application, application code 124 and models and application artifacts 126 be utilized to run tests on the applications, fetch model artifacts (e.g., from model storage 108), and build and push any containers used to deploy the application or model.

Storing text versions of models and applications generally allows for versioning of the applications and models. Versioning allows for developers to track and utilize multiple versions of ML models and applications for different purposes. For example, developers may utilize different versions of the same model for different purposes, track which version of a model is exposed to external users, and/or easily roll back to previous versions of a model when desired.

The ML deployment platform 102 further includes various components for configuring and deploying jobs and infrastructure for deployment of applications and models, as well as maintaining documentation related to such applications. For example, continuous integration/continuous deployment (CI/CD) 114 may configure various jobs executed by the other components of the ML deployment platform 102 upon a change to the codebase. An infrastructure as code 116 component generally previews and deploys any changes to infrastructure occurring as a result of the change to the codebase. A documentation generator 118 may generate documentation related to new applications or models. For example, the documentation generator 118 may build a website from markdown files and docstrings provided with the application or model. The website may be pushed to a private host in communication with the ML deployment platform 102 and may be later accessed by various devices in communication with the ML deployment platform 102. Container orchestration 120 may sync configuration of a new container associated with the application or model and may communicate with the software development kit 122, application code 124, and models and application artifacts 126 to create a new version of an application and its associated container and communicate the new version to the registry 136.

Other devices, such as external user devices 106 may access applications deployed using the ML deployment platform 102. In various examples, the ML deployment platform 102 may make the most recent version of an application available for access and use by external user devices 106 without allowing external user devices 106 to modify the application. For example, external user devices 106 may provide input to a deployed model for analysis and receive output from the deployed model. In some examples, the most recent version of a model or application may be automatically made available to external user devices 106 upon being deployed by the ML deployment platform 102. In some examples, a development device 104 may specify a version of an ML model or application to be made available to external user devices 106 upon deployment.

Development devices 104 may generally access previous versions of applications, models, and/or data using the versioning provided by the ML deployment platform 102. For example, a development device 104 may access a directory at the ML deployment platform 102 including different versions of ML models or applications. Accordingly, developers may utilize or experiment with different versions of ML models. In some examples, multiple versions of an ML model may be simultaneously deployed, with a development device 104 specifying which version of a model is accessible by external user devices 106.

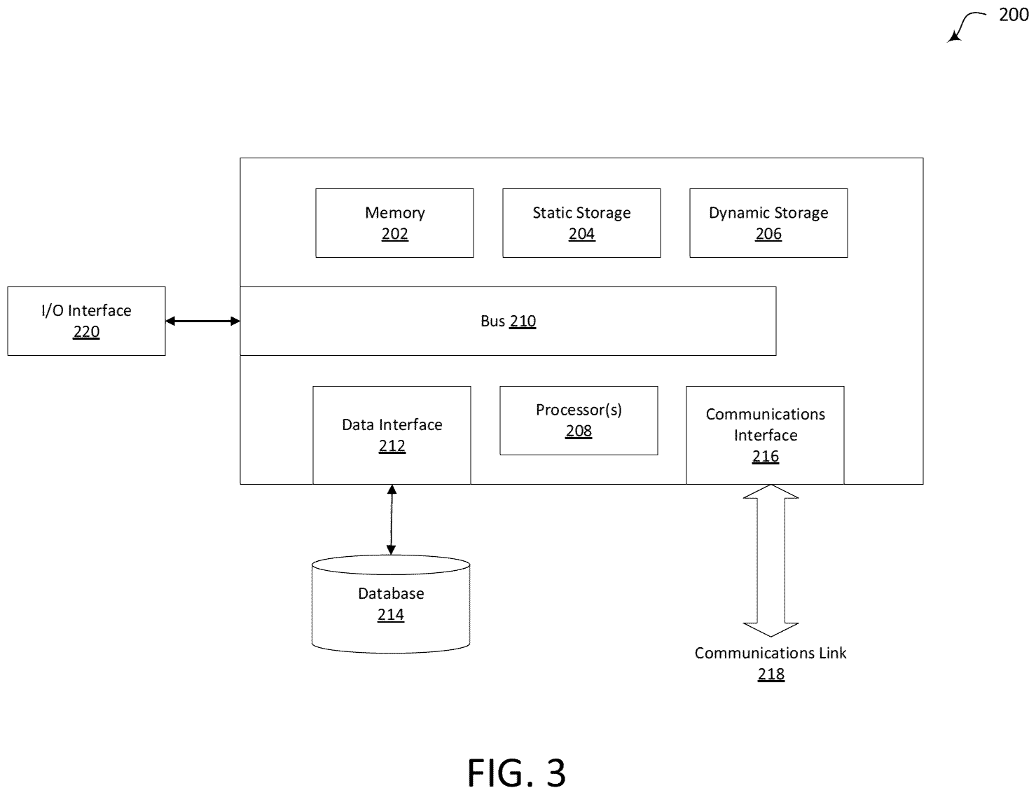

The ML deployment platform 102 may be implemented using various computing systems. Turning to FIG. 3, an example computing system 200 may be used for implementing various embodiments in the examples described herein. For example, the ML deployment platform 102 and various components of the ML deployment platform 102 may be located at one or several computing systems 200. In various embodiments, a development device 104 and/or an external user device 106 is also implemented by a computing system 200. This disclosure contemplates any suitable number of computing systems 200. For example, the computing system 200 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 200 may include one or more computing systems; be unitary or distributed; span multiple locations; span multiple machines; span multiple data centers; or reside in a cloud, which may include one or more cloud components in one or more networks.

Computing system 200 includes a bus 210 (e.g., an address bus and a data bus) or other communication mechanism for communicating information, which interconnects subsystems and devices, such as processor 208, memory 202 (e.g., RAM), static storage 204 (e.g., ROM), dynamic storage 206 (e.g., magnetic or optical), communications interface 216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), and an input/output (I/O) interface 220 (e.g., keyboard, keypad, mouse, microphone). In particular embodiments, the computing system 200 may include one or more of any such components.

In particular embodiments, processor 208 includes hardware for executing instructions, such as those making up a computer program. The processor 208 circuitry includes circuitry for performing various processing functions, such as executing specific software for performing specific calculations or tasks. In particular embodiments, I/O interface 220 includes hardware, software, or both providing one or more interfaces for communication between computing system 200 and one or more I/O devices. Computing system 200 may include one or more of these I/O devices, where appropriate. One or more of these devices may enable communication between a person and computing system 200.

In particular embodiments, communications interface 216 includes hardware, software, or both providing one or more interfaces for communication (such as, for example, packet-based communication) between computing system 200 and one or more other computer systems or one or more networks. One or more memory buses (which may each include an address bus and a data bus) may couple processor 208 to memory 202. Bus 210 may include one or more memory buses, as described below. In particular embodiments, one or more memory management units (MMUs) reside between processor 208 and memory 202 and facilitate access to memory 202 requested by processor 208. In particular embodiments, bus 210 includes hardware, software, or both coupling components of the computing system 200 to each other.

According to particular embodiments, computing system 200 performs specific operations by processor 208 executing one or more sequences of one or more instructions contained in memory 202. For example, instructions for continuous integration/continuous deployment 114, infrastructure as code 116, documentation generation 118, container orchestration 120, and/or the software development kit 122 may be contained in memory 202 and may be executed by the processor 208. Such instructions may be read into memory 202 from another computer readable/usable medium, such as static storage 204 or dynamic storage 206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 208 for execution. Such a medium may take many forms, including but not limited to nonvolatile media and volatile media. Non-volatile media includes, for example, optical or magnetic disks, such as static storage 204 or dynamic storage 206. Volatile media includes dynamic memory, such as memory 202.

Computing system 200 may transmit and receive messages, data, and instructions, including program, e.g., application code, through communications link 218 and communications interface 216. Received program code may be executed by processor 208 as it is received, and/or stored in static storage 204 or dynamic storage 206, or other storage for later execution. A database 214 may be used to store data accessible by the computing system 200 by way of data interface 212. For example, application code 124 and/or models and application artifacts 126 may be stored using a database 214. In various examples, communications link 218 may communicate with, for example, user devices to allow users to access the ML deployment platform 102.

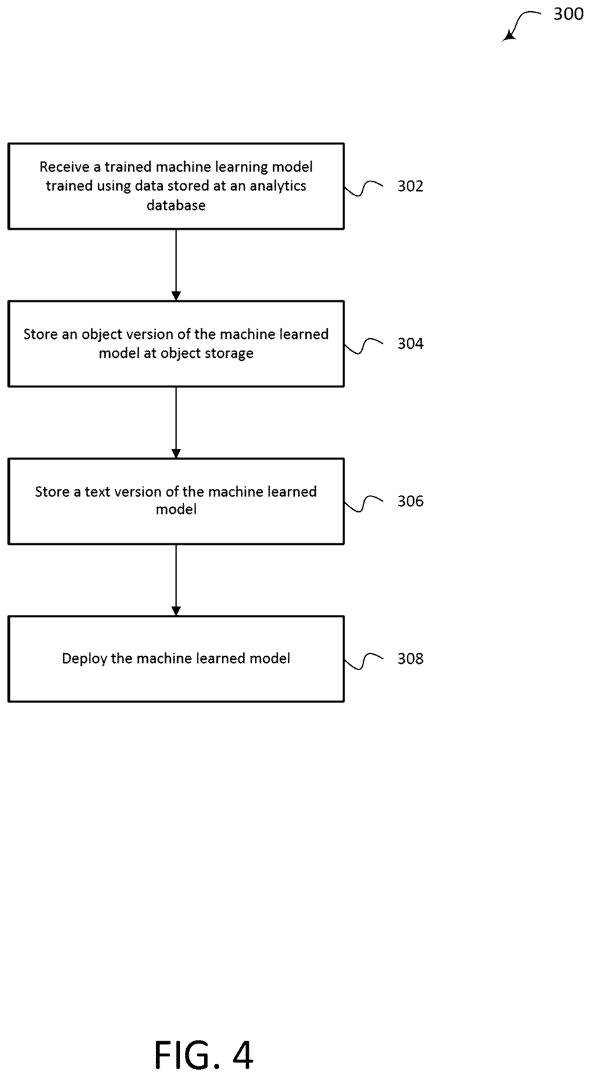

FIG. 4 illustrates an example process 300 for deploying an ML model using an ML deployment platform 102. At block 302, a trained ML model is received, where the trained ML model is trained using data stored at an analytics database 112. Generally, a development device 104 may access the analytics database 112 via a network 110 to obtain data to train a model. The development device 104 may have read only access to the data at the analytics database 112.

An object version of the ML model is stored at object storage at block 304. In various examples, the object version of the ML model may be provided by the development device 104 to model storage 108 as the text version of the model is stored at the ML deployment platform 102. In some examples, the object version of the model may be stored at model storage 108 by the ML deployment platform 102. Generally, the object version of the ML model may be any type of object, including, in some examples, a JSON blob.

At block 306, a text version of the ML model is stored at the ML deployment platform 102. The text version of the model may be received from a development device 104. For example, the development device 104 may communicate with the ML deployment platform 102 to push a new version of a model or a new model to the ML deployment platform 102. The text version of the model may be stored as versioned code at the ML deployment platform 102. In various examples, the text version of a model may include an application, which includes code and a Dockerfile, such that the application may be deployed by the ML deployment platform 102 within a container. In some examples, the text version of the ML model may include a pointer to the object version of the model (e.g., a URI pointer) at model storage 108 such that the ML deployment platform 102 can access the object version of the model as needed to deploy the model.

The ML model is deployed at block 308. In various examples, an ML model may be automatically deployed by the ML deployment platform 102 upon receiving a new version of a model or a new model at the ML deployment platform 102. For example, a development device 104 may push a model to the ML deployment platform 102 via a command line interface provided by the software development kit 122, and the remainder of the deployment process may be automated (e.g., managed by the ML deployment platform 102 without additional input or configuration from the development device 104). Such automation generally improves efficiency of development using ML models.

For example, various jobs may be performed by various components of the ML deployment platform 102 when a new model is pushed to the ML deployment platform 102. In one example, the continuous integration/continuous deployment element 114 may configure the jobs that run when the codebase is changed (e.g., when a model is pushed to the ML deployment platform 102). The infrastructure as code component 116 may execute a job to preview and deploy any changes to the infrastructure resulting from the change to the codebase. For example, the job may include calling an API to an outside service or component to create updated infrastructure. Such an outside service may be, in some examples, a management platform for infrastructure as code.

Responsive to the change in the codebase, a documentation generator 118 may build a website from markdown and docstrings and push the website to a private host associated with the ML deployment platform 102, such as a private documentation website. Container orchestration 120 may synchronize configuration with the job orchestrator 128. For example, container orchestration 120 may create a new version of an application (e.g., using a Dockerfile to configure a container of the application) and, along with the software development kit 122, create the new version of the application within the registry 136.

In some examples, the application may be available to external user device 106 once the application is created within the registry 136. For example, the development device 104 may specify that the newest version of the application should be made available for use by external user devices 106.

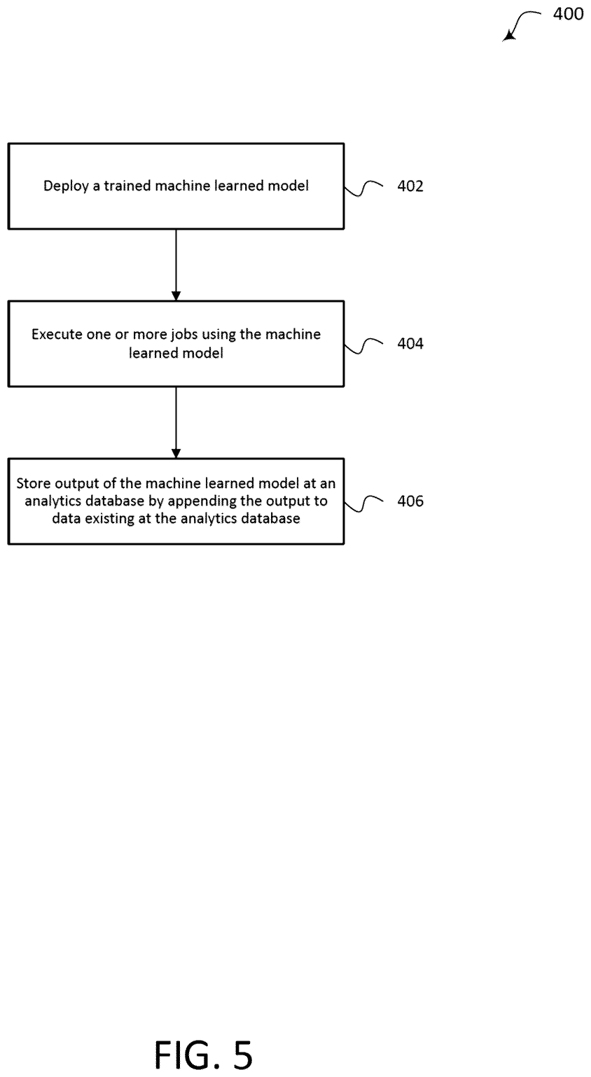

FIG. 5 illustrates an example process 400 for utilizing an ML model using an ML deployment platform 102. At block 402, the ML deployment platform 102 deploys an ML model. The ML deployment platform 102 may deploy the ML model using, for example, the methods described with respect to block 308 of FIG. 4. For example, the ML deployment platform 102 may configure infrastructure, generate documentation, and configure an application including the ML model, where the application includes code for the ML model and a file for configuring a container for executing the application. The ML deployment platform 102 may generally provide the application to a registry 136 for deployment.

The ML deployment platform 102 executes one or more jobs using the ML model at block 404. Generally, the job orchestrator 128 may create jobs to run a specific application and/or associated with a specific application based on configurations received with the model or application. For example, a developer may specify that a container should be run at specific intervals and/or that specific jobs should be run. For example, model scoring 130, feature generation 132, and model monitoring 134 are examples of jobs that may be run for a container of a specific model. The jobs may fetch a specified container from the registry 136 and deploy the container including the model.

At block 406, the ML deployment platform 102 stores output of the ML model at the analytics database 112 by appending the output of the model to data existing at the analytics database 112. In various examples, the jobs run by the job orchestrator 128 may, as needed, fetch data from the analytics database 112. Various outputs from the jobs (e.g., from the model) may be appended to existing data at the analytics database 112.

In some examples, the ML deployment platform 102 may be used to “roll back” or revert a model to a previous version based on manual input and/or based on the output of the ML model. For example, if monitoring of a machine learning model shows unexpected or incorrect output from the ML model, a previous version of the model may be deployed by the ML deployment platform 102.

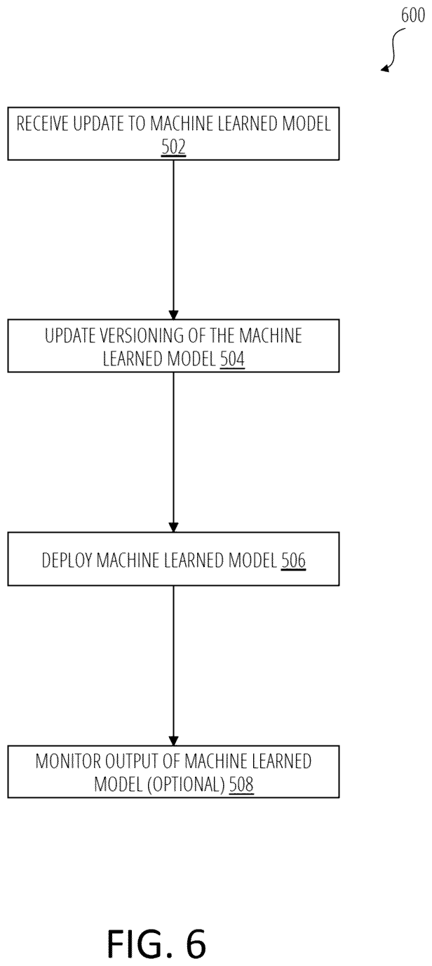

FIG. 6 illustrates an example process 500 for updating an ML model using the ML deployment platform 102. At block 502, the ML deployment platform 102 receives an update to the machine learned model. The update may include an update to the text version of the machine learned model, an update to the object version of the machine learned model, and/or an update to data related to the machine learned model (e.g., training data of the machine learned model stored in analytics database 112). In some examples, the ML deployment platform 102 may receive an updated version or new version of the machine learned model from the development device 104. For example, a user may interface with the software development kit 122 of the development device 104 to access application code 124 of a machine learned model stored in and deployed by the ML development platform 102. The user may update the machine learned model by modifying the application code 124, such as by making a change to the programming code or providing new programming code. The development device 104 may communicate with the ML deployment platform 102 to push the update to the ML deployment device as a new version of the machine learned model.

At block 504, the ML deployment platform 102 updates versioning of the machine learned model based on the update. In some examples, where the ML deployment platform 102 receives an update to the text version of the machine learned model (e.g., a modification of the application code 124 of a machine learned model), the ML deployment platform may generate a new text version of the machine learned model based on the update and store the new text version as versioned code in the ML deployment platform. In such examples, the new text version of the machine learned model may be utilized to generate a new object version of the machine learned model by training the new text version of the machine learned model using training data stored at the analytics database 112. The new object version of the machine learned model may be stored as versioned object code, e.g., in the ML deployment platform 102 and/or the model storage 108. In some examples, the new text version of the machine learned model may include a pointer to the corresponding new object version of the model (e.g., a URI pointer) at model storage 108 such that the ML deployment platform 102 can access the new object version of the model as needed to deploy the model.

In another example, where the ML deployment platform 102 receives an update to the object version of the machine learned model (e.g., the ML deployment platform receives new object code of the machine learned model from the development device 104), the ML deployment platform may generate a new object version of the machine learned model based on the update and store the new object version as versioned object code, e.g., in the ML deployment platform 102.

In another example, where the ML deployment platform 102 receives an update to the data of the analytics database 112 (e.g., the ML deployment platform receives new data appended to or modifying the data of the analytics database 112), the ML deployment platform may generate a new version of the data based on the update and store the new version of the data as versioned data in the analytics database 112. In such examples, the new version of the data may be utilized to generate a new object version of the machine learned model. For example, where the new version of the data includes updated training data, the new version of the data may be used to train the text version of the machine learned model to generate a new object version of the machine learned model. The new object version of the machine learned model may be stored as versioned object code, e.g., in the ML deployment platform 102 and/or the model storage 108.

The new versions of the text version of the machine learned model, object version of the machine learned model, and/or data of the analytics database 112 may include metadata related to versioning, such as a record of the chronology of the new version in relation to previous versions.

At block 506, the ML deployment platform 102 deploys the updated version of the machine learned model. The deployment process may be automated (e.g., managed by the ML deployment platform 102 without additional input or configuration from the development device 104). The ML deployment platform 102 may deploy the ML model using, for example, the methods described with respect to block 308 of FIG. 4. For example, the ML deployment platform 102 may configure infrastructure, generate documentation, and configure an application including the ML model, where the application includes code for the ML model and a file for configuring a container for executing the application. The ML deployment platform 102 may generally provide the application to a registry 136 for deployment.

At block 508, the ML deployment platform 102 optionally monitors the output of the deployed machine learned model. For example, the job orchestrator 136 may create a job for model monitoring 134. The ML deployment platform 102 may execute the model monitoring 134 job to monitor for unexpected or incorrect output from the deployed machine learned model. Where the deployed machine learned model generates unexpected or incorrect output, the machine learned model may be reverted to a previous version of the text version, object version, and/or training data.

According to the above examples, the ML deployment platform 102 provides for increased efficiency in development of ML models and applications incorporating ML models. Additionally, the ML deployment platform 102 allows for versioning of data as well as ML models, improving collaboration between developers and simplifying the development process for ML models. As the ML deployment platform 102 utilizes text versions of models and a shared, immutable data source, the ML deployment platform is scalable as models grow and provides for efficient use of computing resources.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Further, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples, and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method comprising:
receiving a trained machine learned model, the machine learned model being trained using a dataset stored at an analytics database;
storing an object version of the machine learned model at an object storage;
storing a text version of the machine learned model at a machine learning deployment platform;
receiving an update to the trained machine learned model;
updating the object version of the machine learned model and the text version of the machine learned model based on the update to the trained machine learned model;
deploying, by the machine learning deployment platform, the machine learned model; and
storing output of the machine learned model at the analytics database by appending the output to data at the analytics database.

2. The method of claim 1, wherein updating the text version of the machine learned model comprises versioning the text version of the machine learned model based on the received update to the trained machine learned model.

3. The method of claim 1, further comprising:
monitoring output of the machine learned model;
detecting an incorrect output of the machine learned model; and
reverting the update to the object version of the machine learned model and the text version of the machine learned model.

4. The method of claim 1, wherein the text version of the model comprises a pointer to the object version of the machine learned model.

5. The method of claim 1, further comprising executing one or more jobs using the machine learned model.

6. The method of claim 1, wherein deploying the machine learned model comprises deploying the machine learned model within a container.

7. The method of claim 1, wherein the machine learned model is deployed automatically responsive to the receiving the trained machine learned model.

8. A system comprising:
an analytics database;
an object storage; and
a machine learning deployment platform in communication with the analytics database and the object storage, the machine learning deployment platform being configured to:
receive a trained machine learned model, the machine learned model being trained using a dataset stored at the analytics database;
store a text version of the machine learned model at the machine learning deployment platform;
store an object version of the machine learned model at the object storage;
receive an update to the trained machine learned model;
update the object version of the machine learned model and the text version of the machine learned model based on the update to the trained machine learned model;
deploy the machine learned model; and
store output of the machine learned model at the analytics database by appending the output to data at the analytics database.

9. The system of claim 8, wherein updating the text version of the machine learned model comprises versioning the text version of the machine learned model based on the received update to the trained machine learned model.

10. The system of claim 8, wherein the machine learning deployment platform is further configured to:
monitor the output of the machine learned model;
detect an incorrect output of the machine learned model; and
revert the update to the object version of the machine learned model and the text version of the machine learned model.

11. The system of claim 8, wherein the text version of the model comprises a pointer to the object version of the model.

12. The system of claim 8, wherein the machine learning deployment platform is further configured to execute one or more jobs using the machine learned model.

13. The system of claim 8, wherein the machine learning deployment platform is configured to deploy the machine learned model within a container.

14. The system of claim 8, wherein the machine learning deployment platform is configured to deploy the machine learned model automatically responsive to receiving the trained machine learned model.

15. One or more non-transitory computer readable media encoded with instructions which, when executed by one or more processors of a machine learning deployment platform, cause the machine learning deployment platform to:
deploy a trained machine learned model;
execute one or more jobs using the machine learned model; and
store output of the machine learned model at an analytics database by appending the output to existing data at the analytics database.

16. The one or more non-transitory computer readable media of claim 15, wherein deploying the machine learned model comprises deploying the machine learned model within a container.

17. The one or more non-transitory computer readable media of claim 15, wherein the instructions cause the machine learning deployment platform to deploy the trained machine learned model automatically responsive to the receiving the trained machine learned model.

18. The one or more non-transitory computer readable media of claim 15, wherein the instructions further cause the machine learning deployment platform to store an object version of the machine learned model at an object storage remote from the machine learning deployment platform.

19. The one or more non-transitory computer readable media of claim 18, wherein the instructions further cause the machine learning deployment platform to store a text version of the machine learned model at the machine learning deployment platform, wherein the text version of the model comprises a pointer to the object version of the machine learned model.

20. The one or more non-transitory computer readable media of claim 19, wherein the instructions further cause the machine learning deployment platform to:
monitor the output of the machine learned model;
detect an incorrect output of the machine learned model; and
revert to a previous object version of the machine learned model and a previous text version of the machine learned model.
